(19) United States
(12) Patent Application Publication
(10) Pub. No.: US 2020/0311674 A1
(43) Pub. Date: Oct. 1, 2020

(54) METHOD AND APPARATUS FOR FACILITATING A VEHICLE AS A DELIVERY SITE

(71) Applicant: FORD GLOBAL TECHNOLOGIES, LLC, Dearborn, MI (US)

(72) Inventors: Stuart C. Salter, White Lake, MI (US); Aaron Halonen, Brighton, MI (US); David Brian Glickman, Southfield, MI (US); Paul Kenneth Dellock, Northville, MI (US)

(21) Appl. No.: 16/369,941

(22) Filed: Mar. 29, 2019

(51) Int. Cl. G06Q 10/08

(52) U.S. Cl. CPC G06Q 10/08355; G06Q 10/0833; G06Q 10/0832

(57) ABSTRACT

A system includes one or more processors that receive selection of a vehicle, associated with a user profile, for use as a delivery site for a package order, responsive to an online order. The processor(s) are also receive selection of a compartment of the vehicle for use as a delivery bay and receive identification of an intended vehicle location for use as a delivery location. The processors further, responsive to determining that a package is ready for delivery, determine whether the vehicle is at the intended vehicle location, determine whether the compartment is occupied, and notify a package recipient responsive to at least one of the vehicle not being located at the vehicle location or the compartment being occupied.

The illustrative embodiments generally relate to methods and apparatuses for facilitating a vehicle as a delivery site.

### BACKGROUND

Online ordering has become prevalent as a means of obtaining goods, and this mode of procurement typically requires that the ordered goods be delivered. Traditionally, goods are delivered to a front porch, but this can be problematic because of potential for theft and a lack of assurance about the actual delivery occurring. If no one is at home during the day, goods can sit for hours on the porch, increasing the opportunity for a passerby to take the goods.

An alternative that has become more recently popular is for users to pick up goods, ordered online, from the store providing the goods. This, however, requires a trip to the store, which can be an inconvenience that online ordering was intended to obviate in the first place.

### SUMMARY

In a first illustrative embodiment a system includes one or more processors configured to receive selection of a vehicle, associated with a user profile, for use as a delivery site for a package order, responsive to an online order. The processor(s) are also configured to receive selection of a compartment of the vehicle for use as a delivery bay and receive identification of an intended vehicle location for use as a delivery location. The processors are further configured to, responsive to determining that a package is ready for delivery, determine whether the vehicle is at the intended vehicle location, determine whether the compartment is occupied, and notify a package recipient responsive to at least one of the vehicle not being located at the vehicle location or the compartment being occupied.

In a second illustrative embodiment, a method includes determining that an order is ready for delivery to a vehicle. The method also includes contacting the vehicle to determine whether a vehicle location corresponds to a prespecified location for delivery to the vehicle and notifying a vehicle owner responsive to the vehicle not being located at the prespecified location.

In a third illustrative embodiment, a method includes determining that a delivery driver vehicle location is within a predefined distance of a delivery location corresponding to a current vehicle location of a vehicle specified as a recipient vehicle to which a package is to be delivered. The method also includes instructing activation of a vehicle notification system, of the recipient vehicle, responsive to determining that the delivery driver vehicle location is within the predefined distance.

### BRIEF DESCRIPTION OF THE DRAWINGS

FIG. 1 shows an illustrative vehicle computing system;

FIG. 2 shows an illustrative process for delivery selection and configuration;

FIG. 3 shows an illustrative process for delivery availability verification;

FIG. 4 shows an illustrative process for vehicle delivery-related alert provision;

FIG. 5 shows an illustrative process for further alert provision; and

FIG. 6 shows an illustrative delivery driver vehicle discovery assistance process.

### DETAILED DESCRIPTION

As required, detailed embodiments are disclosed herein; it is to be understood, however, that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

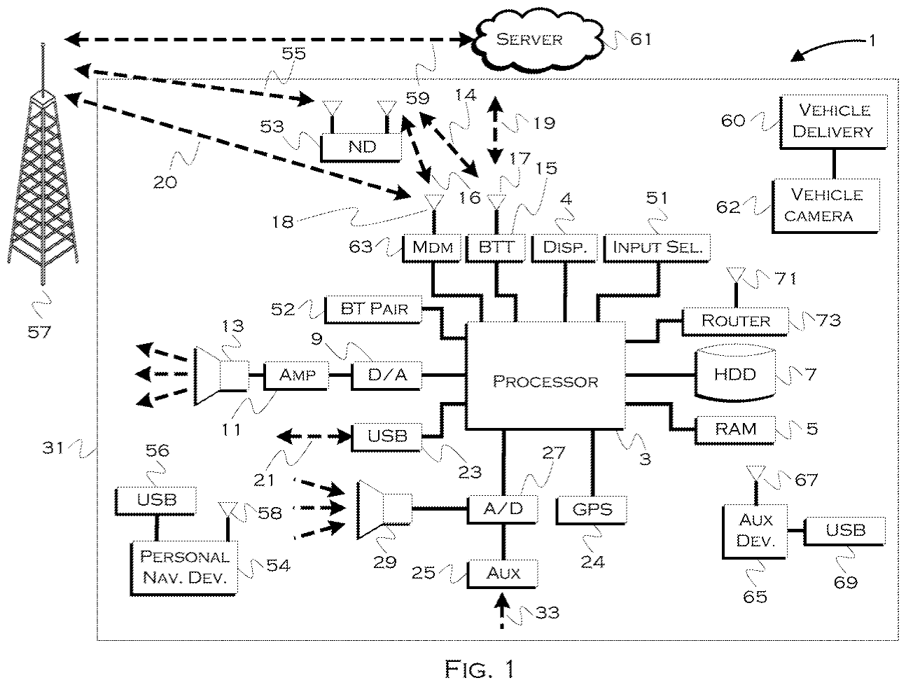

FIG. 1 illustrates an example block topology for a vehicle based computing system 1 (VCS) for a vehicle 31. A vehicle provided with a vehicle-based computing system may contain a visual front-end interface 4 located in the vehicle. The user may also be able to interact with the interface if it is provided, for example, with a touch-sensitive screen. In another illustrative embodiment, the interaction occurs through, for example, button presses, spoken dialog system with automatic speech recognition and speech synthesis.

In the illustrative embodiment I shown in FIG. 1, a processor 3 controls at least some portion of the operation of the vehicle-based computing system. Provided within the vehicle, the processor 3 allows for onboard processing of commands and routines. Further, the processor 3 is connected to both non-persistent 5 and persistent storage 7. In this illustrative embodiment, the non-persistent storage 7 is random access memory (RAM) and the persistent storage 5 is a hard disk drive (HDD) or flash memory. In general, persistent memory 5 can include all forms of memory that maintain data when a computer or other device is powered down. These include, but are not limited to, HDDs, compact discs (CDs), digital video discs (DVDs), magnetic tapes, solid state drives, portable universal serial bus (USB) drives and any other suitable form of persistent memory.

The processor 3 is also connected to a number of different inputs allowing the user to interface with the processor 3. In this illustrative embodiment, a microphone 29, an auxiliary input 25 (for input 33), a USB input 23, a Global Navigation Satellite System (GNSS) input 24, screen 4, which may be a touchscreen display, and a BLUETOOTH input 15 are all provided. An input selector 51 is also provided, to allow a user to swap between various inputs. Input to both the microphone 29 and the auxiliary connector 33 is converted from analog to digital by a converter 27 before being passed to the processor. Although not shown, numerous of the vehicle components and auxiliary components in communication with the processor 3 may use a vehicle network (such as, but not limited to, a CAN bus) to pass data to and from the processor 3 (or components connected thereto).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 along the bi-directional data streams shown at 21.

The vehicle 1 may also include a delivery bay 60, which can be a specialized bay designated for delivery of packages and which may be isolated from the rest of the vehicle 1. This or another portion of the vehicle 1 may be provided with a camera 62 that can scan packages or otherwise recognize a delivery driver or authenticate a delivery driver with the help of the vehicle 1.

In one illustrative embodiment, the system uses the BLUETOOTH transceiver 15 to communicate via antenna 17 with a user's nomadic device (ND) 53 (e.g., cell phone, smart phone, PDA, or any other device having wireless remote network connectivity). The nomadic device 53 can then be used to communicate signal 59 with a server 61 outside the vehicle 31 through, for example, communication 55 with a cellular tower 57 or Wi-Fi access point.

Exemplary communication between the nomadic device 53 and the BLUETOOTH transceiver 15 is represented by signal 14.

Pairing of a nomadic device 53 with the BLUETOOTH transceiver 15 can be instructed through a button 52 or similar input. Accordingly, the processor 3 is instructed that the onboard BLUETOOTH transceiver 15 will be paired with a nomadic device.

Data may be communicated between processor 3 and server 61 utilizing, for example, a data-plan, data over voice, or DTMF tones associated with nomadic device 53. Alternatively, it may be desirable to include an onboard modem 63 having antenna 18 in order to cellularly communicate 16 data between processor 3 and network 61.

In some embodiments, the modem 63 may establish communication 20 with the tower 57 for communicating with server 61. As a non-limiting example, modem 63 may be a USB cellular modem and communication 20 may be cellular communication.

In one illustrative embodiment, the processor 3 is provided with an operating system including an application programming interface (API) to communicate with modem application software. The modem application software may access an embedded module or firmware on the BLUETOOTH transceiver 15 to complete wireless communication 14 with a remote BLUETOOTH transceiver (such as that found in a nomadic device 53). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication format that can be used in this realm is free-space optical communication non-standardized consumer IR protocols.

In another embodiment, nomadic device 53 includes a modem for voice band or broadband data communication. In a data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and the system could use a much wider bandwidth (speeding up data transfer). In still another embodiment, nomadic device 53 is replaced with a cellular communication device (not shown) that is installed in vehicle 31. In yet another embodiment, the nomadic device 53 may be a wireless local area network (LAN) device capable of communication over, for example (and without limitation), a Wi-Fi network.

In one embodiment, incoming data can be passed through the nomadic device 53 via a data-over-voice or data-plan, through the onboard BLUETOOTH transceiver 15 and into the vehicle's internal processor 3. In the case of certain temporary data, for example, the data can be stored on the HDD 7 or other storage media until such time as the data is no longer needed.

Additional sources that may interface with the vehicle include a personal navigation device 54, having, for example, a USB connection 56 and/or an antenna 58, or other connection, an onboard GNSS device 24, or remote navigation system (not shown) having connectivity to server 61.

Further, the processor 3 could be in communication with a variety of other auxiliary devices 65. These devices can be connected through a wireless 67 or wired 69 connection (e.g. USB). Auxiliary devices 65 may include, but are not limited to, personal media players, wireless health devices, portable computers, and the like.

Also, or alternatively, the processor 3 could be connected to a vehicle based wireless router 73, using for example a Wi-Fi (IEEE 802.11) 71 transceiver. This could allow the processor 3 to connect to remote networks in range of the local router 73.

In addition to having exemplary processes executed by a vehicle computing system located in a vehicle 31, in certain embodiments, the exemplary processes may be executed by a computing system in communication with a vehicle computing system. Such a system may include, but is not limited to, a wireless device 53 (e.g., and without limitation, a mobile phone) or a remote computing system (e.g., and without limitation, a server on a remote network 61) connected through the wireless device 53 or a vehicle modem 63. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device 53, then it is likely that the wireless device 53 is not performing that portion of the process, since the wireless device would not send and receive information with itself. One of ordinary skill in the art will understand when it is inappropriate to apply a particular VACS to a given solution.

As an alternative to porch delivery, in-vehicle delivery represents a system with several advantages. First, the vehicle 1 is typically a secure location, having lockable systems and representing an enclosed space. Further, the user is typically at or in proximity to a vehicle 1 location, and thus can easily and quickly confirm that the package is delivered and/or in acceptable condition.

Since vehicles 1 are mobile, unlike a porch, coordinating a delivery may require that the vehicle 1 be located at a prespecified location during a prespecified time. This can often be at a user house or a user work location. Even if the user is at home, they may be occupied with children or otherwise indisposed, and thus in-vehicle delivery is still a suitable option even at a home location.

Moreover, vehicles 1 lack addresses and can frequently appear to be similar to other vehicles at the same location. While license plates are usable to distinguish vehicles 1 from each other, those plates may be difficult to read, especially if covered in snow or in the dark or rain, and thus locating a particular vehicle 1 can be difficult in a large parking lot. Modem GNSS systems are often only accurate within an error tolerance, and this can leave a wide variety of parking spaces as a potential location for a vehicle, even if the GNSS coordinates of the vehicle 1 are known.

Delivery drivers must also have a means of accessing the vehicle 1, since vehicles 1 are typically locked systems. The driver may need to access otherwise secure areas of a vehicle 1, and will also want to leave the vehicle 1 secure following the access.

In order to address some of the potential challenges associated with in-vehicle delivery, the illustrative embodiments provide aspects of the solution that solve issues related to in-vehicle delivery. Among other things, the embodiments provide a configurable predefined location for delivery, as well as alerts that assist in ensuring that the vehicle 1 is on-site at the correct location and that a vehicle 1 receptacle is available for delivery. Further, the embodiments provide for user-configurable limited-access to constrained vehicle 1 compartments (e.g., special package bay, trunk, or vehicle interior). The embodiments additionally function to provide improved temporary vehicle 1 location services, that can respond to a delivery driver's presence and assist a driver in efficiently locating a vehicle 1, even at night or in inclement weather.

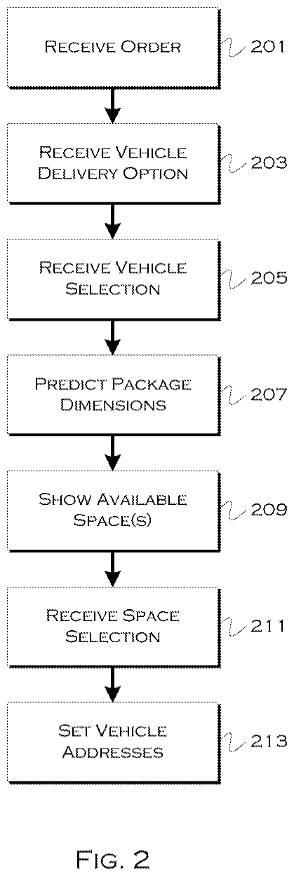

FIG. 2 shows an illustrative process for delivery selection and configuration executable by an order processing server 61, for example. This illustrative process demonstrates how in-vehicle delivery can be configured when an order is placed, even though the particular time for delivery, or even date for delivery, may not be known. This example also contemplates a vehicle 1 provided with at least one specialized delivery bay, in some embodiments.

In this example, an online ordering server 61 receives an order for a good at step 201. This portion of the process can be similar to many existing online ordering processes, where a user typically will select a delivery option during the order process.

Unlike typical ordering processes, however, in this example the user can select a vehicle 1 as a delivery option at step 203. The user may have a list of owned vehicles 1 saved with respect to an account or a profile accessible during an ordering process. Among other things, each vehicle 1 may include a profile with identifying information (color, make, model, license plate, etc.), capacity information (trunk size, interior size, access port sizes, special delivery box size, etc.) and common location information (e.g., where the vehicle is frequently parked for long periods of time).

The user may be able to view the particulars of a given vehicle 1, and the ordering system may even remove or block options unsuitable for delivery of a particular good (e.g., a compact car when a television is ordered). In this example, the user selects a vehicle 1 at step 205 and the server estimates package dimensions at step 207, but the steps could be done in reverse if the server 61 was capable of removing options for which delivery was unsuitable.

In this example, once the package dimensions are known or estimated, the server 61 shows usable delivery bays at step 209. While the interior of the vehicle 1 will frequently be large enough for virtually any package, due to security concerns, the user may prefer to have the package placed in a trunk or in a special compartment. This avoids having the driver access the vehicle 1 interior, as well as prevents the package from sitting in plain sight until the owner returns to the vehicle 1. Thus, in this example, the user can select from any space determined to be large enough to fit the dimensions of the package at step 211, and the user can also set or select an intended address at step 213.

Since it is not always clear when a delivery will occur, the user may set separate addresses for different times of day (e.g., a work address from 9-5, and a home address other times). Presumably, when the package arrives for delivery, the delivery system will be able to plan within a large time window or route the package to the appropriate entity for delivery at the location correlating to a given time window.

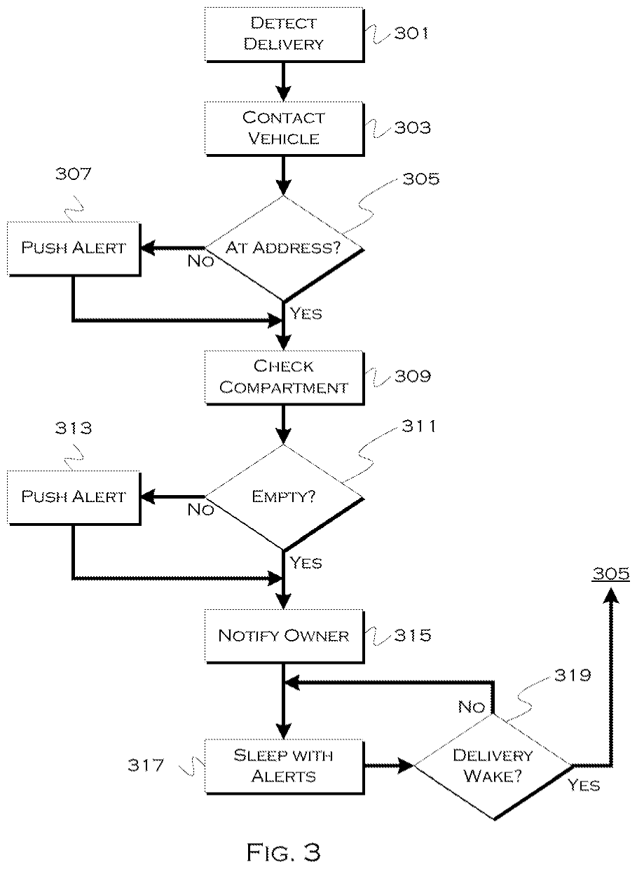

FIG. 3 shows an illustrative process for delivery availability verification executable by an order processing server 61, for example. In this example, the server 61 may detect or determine that a package is ready for delivery at step 301 (e.g., the package has arrived at a shipping location and will go out that day with a shipment). This process could be executed by a merchant site, by the delivery company or by a third party (e.g., a manufacturer) working in conjunction with either entity.

In this example, the server 61 contacts the vehicle 1 (e.g., via cellular or Wi-Fi communication) at step 303. The server 61 can then confirm whether the vehicle 1 is at an intended location (typically specified during ordering) at step 305. If the vehicle 1 is not at the intended location, and/or if the time of day is within a time slot specified for that location, the server may push an alert to the vehicle at step 307. The server 61 may also queue an alert for delivery to the owner via another medium other than the vehicle 1, in case the owner fails to use the vehicle 1 that day.

Also, in this example, the server 61 checks the compartment at step 309 with assistance from the vehicle 1. This can include a visual or other scan of the interior of smaller compartments (e.g., trunks, specialized delivery slots) and/or can use weight sensors and other low-cost methods of determining that the compartment is occupied. The vehicle 1 can report compartment availability back to the server 61. If the compartment is not empty at step 311, the server 61 may also push and/or queue another alert at step 313. Then, in this example, the server 61 may notify the owner of any pending alerts at step 315. This can include, for example, sending emails, text messages, etc., as well as in-vehicle delivery of messages if the vehicle 1 is currently in use, and/or is in use prior to scheduled delivery.

For example, a user may define a work location as an intended location from 9 AM to 5 PM on Monday. Once the package is ready for delivery on Monday, the server 61 may communicate with the vehicle at 8:45 AM and determine that the vehicle 1 is at a home location and is not in use. The server 61 may queue an alert for the location, as well as push an alert to the vehicle 1. The server 61 may also receive indication that the trunk is occupied with current objects, and may further queue an alert for the compartment (trunk) and push an alert to the vehicle 1.

Since it is 8:45 AM, the server 61 may wait until 9 AM to send a mobile alert about the vehicle 1 location, but the server 61 may immediately send the compartment-occupied alert so the user can empty the compartment before leaving the house. The alert may also give the user an option to choose a new, suitable compartment, if the user does not want to empty the occupied compartment.

At 9 AM, the server 61 may send the location alert, and when the user enters the vehicle at 9:15 AM, the vehicle 1 may also use the pushed alert to notify the user, in-vehicle, that the vehicle is not at the intended location. If permissible, the alert may include an option to select a new location, but this availability may vary based on delivery, because of the routing issues this may cause for the delivery company. If the user emptied the compartment or selected a new compartment, responsive to the text or email alert about compartment occupancy, the server 61 or vehicle 1 may forego the compartment alert, unless the newly selected compartment is also occupied.

In this example, following vehicle 1 communication, the server 61 may instruct the vehicle 1 to sleep at step 317, waking at a delivery time at step 319 and/or waking when a driver enters the vehicle 1, or periodically, if there are additional alerts pertaining to occupied compartments and/or vehicle 1 location.

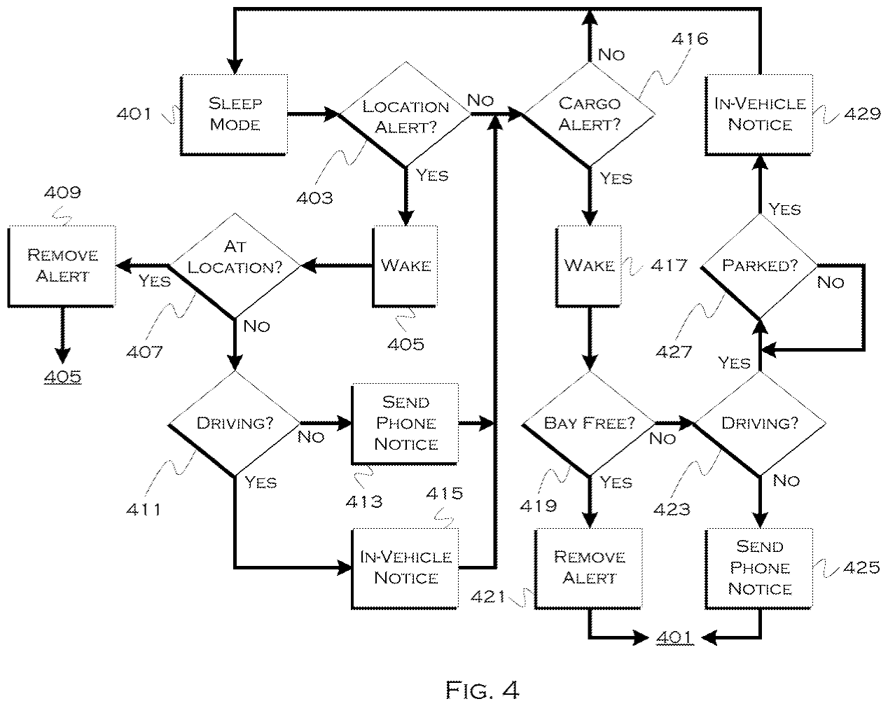

FIG. 4 shows an illustrative process for vehicle delivery-related alert provision executable by, for example, the processor 3 of the vehicle 1. In this example, a vehicle 1 has been placed in sleep mode at step 401, with one or more alerts relating to location and/or compartment occupancy still pending. If a prescribed time period for rechecking the alert conditions passes, the vehicle 1 can determine at step 403 if a location alert is still pending. The vehicle 1 can then wake at step 405 and determine if it has reached the intended location at step 407. It may also be the case that the vehicle 1 never moved, but that passage of time has rendered the present location the intended location for a now-achieved time window, rendering the alert obsolete for the present time. So, in this example, the vehicle 1 not only determines where it is located, but also whether that location is correct for the current time of day.

If the vehicle 1 location corresponds to where the vehicle 1 is supposed to be located, the vehicle 1 can dequeue the alert at step 409, and then proceed to step 405. Otherwise, the vehicle 1 determines if the vehicle 1 is in use at step 411. If the vehicle 1 is not in use, the vehicle 1 may send a mobile notice to the user at step 413. This can be a message directly from the vehicle 1 or can be a message to a remote server 61 instructing the server 61 to contact the user. In still other examples, the remote server 61 may monitor the location and occupancy conditions, but the illustrative solution places some of the monitoring in a distributed solution.

If the vehicle 1 is currently in use, the vehicle 1 may display the alert (or play the alert) in vehicle at step 415. This will hopefully notify the driver that the vehicle needs to be relocated with some degree of haste, lest the delivery be missed.

In a similar manner, the process may wake at step 407 if it determines at step 405 that an alert about a specified compartment being occupied is pending. In this example, the vehicle 1 checks to see if the compartment is still occupied at step 419. If the compartment is available, the vehicle 1 may remote the alert at step 421. Otherwise, the vehicle 1 may again determine if the vehicle 1 is in use at step 423.

If the vehicle 1 is not in use, the vehicle 1 may send a mobile alert at step 425, similar to the mobile alert sent at step 413. The two alerts (and any other alerts) can also be sent in conjunction, and some or all alerts may include options to reselect or respecify new options for delivery, compartments, etc. In this example, if the vehicle 1 is in use, the vehicle 1 waits until the vehicle 1 is parked at step 427, before issuing an in-vehicle notification about the compartment being occupied at step 429. While not necessary, waiting until the vehicle 1 is parked for this particular alert may remind the user to free up the compartment at a time when the user can actually exit the vehicle 1 and empty the compartment.

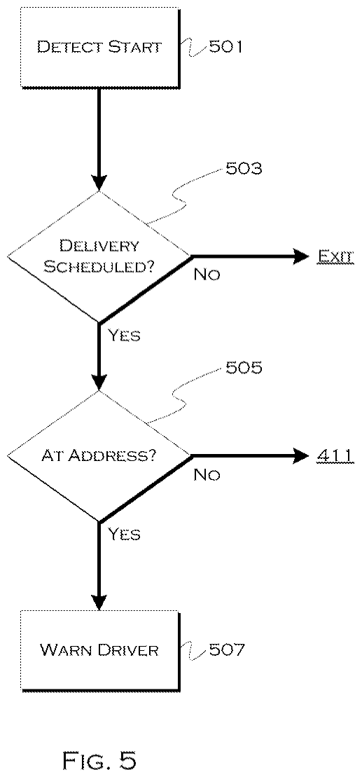

FIG. 5 shows an illustrative process for further alert provision, again executable by a vehicle 1 processor 3. This example demonstrates how the vehicle 1 can act in a seemingly self-aware manner to prevent an owner from inadvertently moving the vehicle 1 before delivery. In this example, the vehicle 1 detects a vehicle 1 start at step 501, and determines if there is a delivery scheduled for that vehicle 1 at step 503. This can include, for example, contacting a remote server and/or checking onboard for pending delivery instructions.

If the vehicle 1 is presently at an address specified for delivery at step 505 and a delivery is pending, the system may warn the driver not to move the vehicle 1 at step 507. In an alternative example, if the driver still elected to move the vehicle 1, the process may send an alert to the delivery driver to delay the delivery attempt, and the alert could include an intended-use time (e.g., lunch hour) for the vehicle 1. A different confirmation could be sent when the vehicle 1 was returned to the prespecified location for delivery.

Similar notices about compartment usage could occur. For example, if a user went to the grocery store at lunch and filled a trunk with groceries, the alert may remind the user that a television was supposed to be delivered and placed in the trunk later that day. The user could then either move the groceries or select a new compartment for delivery.

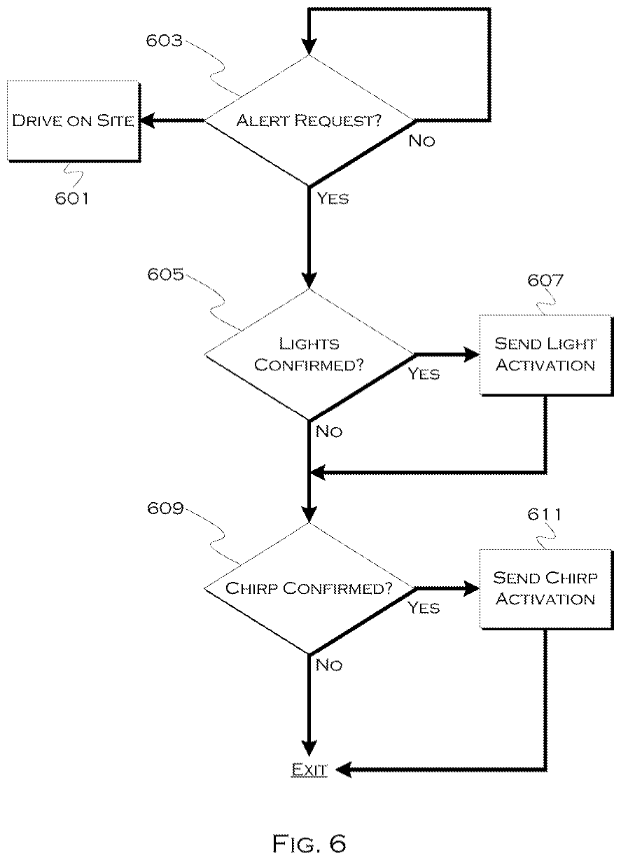

FIG. 6 shows an illustrative delivery driver vehicle discovery assistance process, executable by a vehicle 1 processor 3. In this example, the vehicle 1 may assist a delivery driver in locating the vehicle 1 when the driver is on site. In addition to obtaining to access the vehicle 1, which will also be discussed, the driver must locate the vehicle 1 as well, which can be difficult in a multi-level garage, in snow or rain, or at night (among other reasons). In this example, the vehicle 1 determines at step 601 that the delivery driver is on-site or within a predefined distance of the vehicle 1 location.

The driver may send an alert request, or, in some examples, it may be automatic when the driver is on site. If an alert request is received at step 603, the vehicle 1 may send a message to a user requesting confirmation to engage lighting at step 605 and/or chirps or a horn at step 607. In some examples, the execution of the lighting alerts and/or audible alerts may be automatic, but if the user works at a hospital, for example, the employer may not want car horns honking every time a delivery arrives to a garage that may hold hundreds of vehicles (i.e., 100 deliveries may equal 100 honks). Thus, in this example, the process may activate the lights at step 607 or the chirp/horn at step 611 responsive to user confirmation (e.g., received from a mobile device in response to a message).

The driver may also need to access a vehicle 1 upon arrival. Access can be based on, for example, definition of a special one-time key or code to open a specified bay, or even based on detecting a delivery driver mobile device that has a pre-loaded authentication code stored thereon.

In other examples, as discussed in the co-pending and incorporated application, a vehicle 1 camera 62 can be used to verify the package label and/or a driver. The bay 60 may then automatically open, or a user can use a phone to confirm access for a limited use or time. Even if a vehicle bay 60 does not have a dedicated keypad or code input, a delivery driver may use a code-pad on a mobile device to input a one-time code, and the vehicle 1 may respond to the code by opening the specified bay 60.

The code may only be active for a short time period, during a delivery window, after the driver arrives on-site, etc., and thus even if the code is included on the physical packaging, the code will not likely be abusable to open the vehicle for any purpose other than that of the delivery driver. The code can also be deactivated after a single use, so that even if the packaging is visible from outside the vehicle 1, the code may not be reusable. In other examples, the delivery driver may have authentication credentials digitally provided by a mobile device or may receive the code electronically responsive to arriving at the vehicle 1 location, avoiding any risk of printing the code on the package. This can avoid, for example, a thief imaging the label from outside the vehicle 1 and then presenting the image, zoomed in, for scanning to gain access.

The illustrative embodiments allow for technological improvement of practical implementations of in-vehicle delivery systems, by ensuring the vehicle is correctly located, at correct time, and has correct access availability to facilitate delivery. Further, the limited use access provisions improve security as well, and the comprehensive system can ensure that packages are efficiently, securely and effectively delivered without undue burden on a delivery driver or a significant number of missed deliveries.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety and are understood to be examples of types of processes that may be performed to achieve elements of the invention. Additional steps may be added or removed from the exemplary processes as desired.

With respect to the illustrative embodiments described in the figures showing illustrative process flows, it is noted that a general-purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
one or more processors configured to:
responsive to an online order:
receive selection of a vehicle, associated with a user profile, for use as a delivery site for a package order;
receive selection of a compartment of the vehicle for use as a delivery bay;
receive identification of an intended vehicle location for use as a delivery location; and
responsive to determining that a package is ready for delivery:
determine whether the vehicle is at the intended vehicle location;
determine whether the compartment is occupied; and
notify a package recipient responsive to at least one of the vehicle not being located at the vehicle location or the compartment being occupied.

2. The system of claim 1, wherein the intended vehicle address also includes identification of a time slot when the vehicle will be parked at the vehicle location.

3. The system of claim 2, wherein the processor is configured to delay notification responsive to the vehicle not being located at the vehicle location until a current time is within the time slot.

4. The system of claim 1, wherein the processor is configured to notify the recipient via text messaging, email or via a mobile application.

5. The system of claim 1, wherein the processor is configured to notify the recipient via an in-vehicle system, responsive to the processor further determining that the vehicle is in use.

6. The system of claim 1, wherein the notification includes identification of the intended vehicle location when the notification is responsive to the vehicle not being located at the intended location.

7. The system of claim 6, wherein the notification includes an option to specify a new intended vehicle location.

8. The system of claim 1, wherein the notification includes identification of the vehicle compartment when the notification is responsive to the compartment being occupied.

9. The system of claim 8, wherein the notification includes an option to specify a new vehicle compartment.

10. A method comprising:
determining that an order is ready for delivery to a vehicle;
contacting the vehicle to determine whether a vehicle location corresponds to a prespecified location for delivery to the vehicle; and
notifying a vehicle owner responsive to the vehicle not being located at the prespecified location.

11. The method of claim 10, further comprising:
contacting the vehicle to determine whether a vehicle compartment, prespecified for use to complete the delivery, is currently occupied, based on data received from the vehicle; and
notifying the owner responsive to the compartment being occupied.

12. The method of claim 11, further comprising pushing notifications corresponding to the location or compartment to a vehicle computer.

13. The method of claim 11, further comprising receiving a new compartment specification responsive to the notification relating to the compartment being occupied and changing a delivery instruction to match the new compartment specification.

14. The method of claim 10, further comprising:
receiving a new location specification responsive to the notification relating to the vehicle not being at the location;
determining whether the new location is within a delivery area previously defined for the order; and
changing a delivery instruction to match the new location specification, responsive to the new location being within the delivery area.

15. The method of claim 10, further comprising:
determining whether a time window, pre-associated with the prespecified location has been reached; and
delaying the notifying until the time window has been reached, responsive to the time window not yet having been reached.

16. A method comprising:
determining that a delivery driver vehicle location is within a predefined distance of a delivery location corresponding to a current vehicle location of a vehicle specified as a recipient vehicle to which a package is to be delivered; and
instructing activation of a vehicle notification system, of the recipient vehicle, responsive to determining that the delivery driver vehicle location is within the predefined distance.

17. The method of claim 16, wherein the instructing includes sending an instruction from a remote server to the recipient vehicle.

18. The method of claim 17, wherein the instructing follows receipt of confirmation from a recipient vehicle owner that the recipient vehicle notification system should be activated, the confirmation requested responsive to determining that the delivery driver vehicle location is within the predefined distance.

19. The method of claim 18, wherein the confirmation includes specification of which of a plurality of notification systems should be activated, and wherein the instructing includes instructing activation of the specified system.

20. The method of claim 16, wherein the instructing activation is further responsive to receiving a wireless request for assistance from a delivery driver driving the delivery driver vehicle.
